(19) United States
(12) Patent Application Publication
(10) Pub. No.: US 2023/0232949 A1
(43) Pub. Date: Jul. 27, 2023

(54) Multifunctional Bag

(71) Applicant: Peterpoint Xiamen Imp. & Exp Co., Ltd, Xiamen (CN)

(72) Inventor: Dongmiao PENG, Xiamen (CN)

(21) Appl. No.: 18/086,654

(22) Filed: Dec. 22, 2022

(30) Foreign Application Priority Data
Jan. 24, 2022 (CN) 202220178577.1
Nov. 30, 2022 (CN) 202223196848.5

(51) Int. Cl. A45C 3/06; A45C 13/30; A45C 13/00; A45C 13/10

(52) U.S. Cl. CPC A45C 3/06; A45C 13/30; A45C 13/001; A45C 13/103

(57) ABSTRACT

The present disclosure discloses a multifunctional bag, including a bag body provided with a side bag at one side of the bag body. The side bag is detachably fixed on the bag body, the side bag has a double-layer structure formed by stitching a shell fabric and a lining. The side bag is mounted with an electric heating material, and the electric heating material is connected to an external power bank through a wire. Not only the original storage function of the bag is maintained, but also an excellent hand warming function is added. It is suitable for use in cold places and can be applied to various bags.

### TECHNICAL FIELD

The present disclosure relates to a multifunctional bag, and in particular, to a multifunctional bag structure with a storage function and a hand warming function, suitable for a shoulder bag, a handbag or a knapsack.

### BACKGROUND

As we all know, shoulder bags, handbags or knapsacks are several types of bags that are often used in daily life. Most of these bags are only used to store and carry items, and have no other functions. In cold weather, the fingers are affected by the temperature, and the capillaries shrink, causing the blood flow to decrease and slow down, the hands will be cold or even numb. In general, people buy a warm handbag to cover their hands.

The warm handbag sold online is generally made of thicker cloth to form a tubular shape, and its structure is roughly as a container-type toy backpack disclosed by CN204812482U, which includes a bag cover, a hand warmer and shoulder straps. The bag cover is connected to the hand warmer, and the free end of the bag cover is fastened with a suction-type magnetic button to the hand warmer. The inner side of the bag cover is equipped with a sub-button of the suction-type magnetic button. The hand warmer is mounted with a female button at a position of the surface adapted to the sub-button. A fur decorative layer is provided at the position where the outer side of the bag cover is adapted to the sub-button, and a leather decorative layer is provided around the female button on the surface of the hand warmer. A zipper is provided on the outer side of the bag cover, and a pocket is provided inside the bag cover. There are two mounting rings provided at the outer junction of the bag cover and the hand warmer, and the mounting rings are connected to the shoulder straps through a metal chain. Hand-in pocket are provided on both sides of the hand warmer, and hollow sockets are provided at the upper of the hand warmer. The structure is simple, with elegant appearance and convenient use, has the functions of storage and warming, and can normally use electronic equipment for learning and entertainment during warming.

However, after careful analysis of this container-style toy backpack, it is not difficult to find its problems:

First, the body is a hand warmer with hand-in openings at both ends. The hand warmer itself does not have the function of storage, but the bag cover has. The bag cover is mainly used to store a hot water bottle and some daily necessities. After putting the hot water bottle in the bag cover, the rest for storing items becomes extremely small, and it is difficult to store other daily necessities. It is indeed a veritable “toy” backpack with poor practicality.

Second, the hand warmer is to provide hand warming function by the hot water in the hot water bottle, just lost the hand warming function after the temperature of hot water drops.

Third, if after the bag cover is disassembled, the hand warming performance of the hand warmer as the body is greatly reduced, and the hand warmer is also useless, which is cumbersome and poor in practicability.

Fourth, the hot water bag is relied on to warm hands. The hot water bag is heavy and inconvenient to carry, and is not suitable for outdoor use, let alone cold places.

Fifth, in view of the above-mentioned poor warming effect, it is further required that the material of the hand warmer must be thick and warm. Usually, it is sewn with flannelette, which is easy to be stained with dust and is inconvenient to clean.

### SUMMARY

The present disclosure is intended to provide a multifunctional bag, such that the original storage function of the bag can be maintained and an excellent hand warming function can be added, which is suitable for use in cold places and can be applied to various bags.

In order to achieve the above object, the solution of the present disclosure is:

A multifunctional bag, comprising a bag body provided with a side bag at one side of the bag body; wherein the side bag is detachably fixed on the bag body, the side bag has a double-layer structure formed by stitching a shell fabric and a lining; the side bag is mounted with an electric heating material, and the electric heating material is connected to an external power bank through a wire.

A hand-in space with a hand-in opening is formed between the side bag and the bag body, the shell fabric of the side bag is provided with an outer pocket for storing the power bank and small items, the outer pocket is mounted with an outlet for connecting the power bank; and the electric heating material is mounted on the lining, and is connected with the outlet through the wire.

An upper side and a lower side of the side bag are detachably fixed on the bag body, respectively, such that the hand-in opening is formed among a left side and a right side of the side bag and the bag body.

The upper side and the lower side of the side bag are respectively fixed on the bag body through zippers.

The upper side and the lower side of the side bag are respectively fixed on the bag body through studs.

The outer pocket on the shell fabric has a structure in which three sides are stitched and one side is mounted with a zipper.

The lining is provided with an interlayer, and the electric heating material is fixed in the interlayer.

The lining is provided with an inner pocket for storing the electric heating material, and the electric heating material is placed in the inner pocket in a flexible manner; the inner pocket is mounted with an inlet for connecting the electric heating material, and the inlet is connected with the outlet through the wire.

The inner pocket on the lining has a structure in which three sides are stitched and one side is mounted with a zipper.

The side bag is provided on an entire back of the bag body, the side bag is provided with an inflatable airbag and a massager composed of a massage head and a driving motor; the massage head and the electric heating material are mounted on the shell fabric of the side bag, wires of the electric heating material and the driving motor pass out from the side bag for connecting to the power bank, and the wires are mounted with an electric switch configured for controlling a power on-off for the electric heating material and the driving motor, the electric switch is mounted on the lining of the side bag; the lining of the side bag is further mounted with an inflation port for inflating the inflatable airbag, and a deflation port for deflating the inflatable airbag; the deflation port and the electric switch are arranged side by side; a switch element is provided between the deflation port and the electric switch, and the switch element is configured for switching and controlling that the electric switch is unable to be turned on when the deflation port is closed, and the electric switch is able to be turned on only after the deflation port is opened.

The inflation port and the deflation port are respectively equipped with an inflation switch piece and a deflation switch piece, and the deflation switch piece is the switch element;

when the deflation switch piece is covered on the deflation port, the deflation port is closed, and the electric switch is blocked under the deflation switch piece and unable to be opened; and

when the deflation switch piece deviates from the deflation port, the deflation port is opened, and the electric switch is exposed and able to be opened.

The lining of the side bag is further mounted with a press-type inflation valve, and the press-type inflation valve is connected with the inflatable airbag.

A periphery of the side bag is fixed on the bag body through a zipper.

The lining of the side bag is further mounted with a tie, and when the lining is folded to the shell fabric, the lining is fixed by a zipper, such that the side bag forms a pillow bag with the tie positioned at two ends of the pillow bag.

The tie is composed of two straps and a pair of adjusting buckles; ends of the two straps are respectively fixed to the lining of the side bag by corresponding to two ends of the pillow bag, another ends of the two straps are mounted with the pair of adjusting buckles, and the two straps are capable to be buckled together through the pair of adjusting buckles.

The bag body is a shoulder bag, a handbag or a knapsack.

The bag body is provided with a hand strap in a middle of an upper of the bag body, and lugs at both sides of the upper of the bag body, and the lugs are detachably mounted with braces.

After adopting the above structure, the present disclosure has the following advantages compared with the prior art:

First, the bag body maintains the original storage function of the bag, which can store larger items, and the side bag further provides the storage function of small items, expanding the storage capacity of the product.

Second, a hand-in space with a hand-in opening is formed between the side bag and the bag body, when powered by the power bank, the electric heating material is energized and heated. When in use, hands are inserted between the bag body and the side bag through the hand-in opening, and the hand warming function will be realized by heating with the electric heating material.

Third, if the side bag is disassembled, the bag body still maintains the original storage function of the bag, which is highly practical.

Fourth, hand warming is relied on the electric heating material. The electric heating material is light in weight and easy to carry, especially suitable for outdoor use, and is more suitable for use in cold places.

Fifth, the product has an excellent warming effect and does not need to be specially made of thick materials. It can maintain the characteristics of the original bag and is made of conventional materials, which is easy to clean.

Sixth, the inflatable airbag of the side bag can be inflated to make the back of the bag expand as a whole, so as to avoid the items in the bag from squeezing the body. When carried as a backpack, it can decompress and reduce the burden on the back of the human body and protect the spine.

Seventh, the side bag can be disassembled from the bag body, and the inflatable airbag can be inflated to be used as a back cushion, or the side bag can be further folded and then inflated to be used as a neck pillow.

Eighth, the massager can be energized to work to realize the massage function, and the electric heating material can also be energized to generate heat to realize functions such as hand warming.

Ninth, the switch element is adopted to make the electric switch unable to open when the deflation port is closed. Only after the deflation port is opened, the electric switch can be opened. In this way, after the inflatable airbag is inflated, the massager works and the heat generated by the electric heating material can make the gas expand, resulting in that the air pressure rises, causing unsafe problems such as explosions.

In a word, the present disclosure combines storage, heat generation (hand warming), folding, neck pillow, back cushion, massage and other functions in one, forming a new kind of multi-purpose bag.

The present disclosure will be further described below in conjunction with the accompanying drawings and specific embodiments.

### BRIEF DESCRIPTION OF DRAWINGS

FIG. 1 is a schematic structural view according to Embodiment 1 of the present disclosure;

FIG. 2 is a schematic diagram according to Embodiment 1 of the present disclosure after the side bag is removed;

FIG. 3 is an exploded view illustrating a side bag structure according to Embodiment 1 of the present disclosure;

FIG. 4 is a schematic diagram illustrating a lining of the side bag according to Embodiment 1 of the present disclosure;

FIG. 5 is a schematic diagram illustrating a back side of the bag body according to Embodiment 2 of the present disclosure;

FIG. 6 is a schematic diagram illustrating the side bag facing inward according to Embodiment 2 of the present disclosure;

FIG. 7 is a schematic diagram illustrating the side bag facing outward according to Embodiment 2 of the present disclosure;

FIG. 8 is a schematic diagram illustrating a use of the switch element according to Embodiment 2 of the present disclosure in a closed state of the inflation port;

FIG. 9 is a schematic diagram illustrating the use of the switch element according to Embodiment 2 of the present disclosure in an open state of the inflation port;

FIG. 10 is a schematic diagram illustrating the use according to Embodiment 2 of the present disclosure as a pillow.

Note:

bag body 1, hand strap 11, lug 12, brace 13;

side bag 2, shell fabric 21, lining 22, outer pocket 23, outlet 24, inner pocket 25, electric switch 26, tie 27, strap 271, adjusting buckle 272;

hand-in opening 3;

zipper 4;

electric heating material 5;

inflatable airbag 6, inflation port 61, inflation switch piece 611, deflation port 62, deflation switch piece 621, press-type inflation valve 63;

massage head 7;

wire 8.

### DESCRIPTION OF EMBODIMENTS

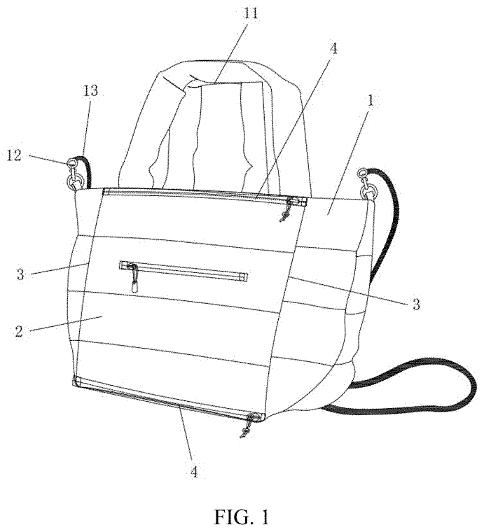

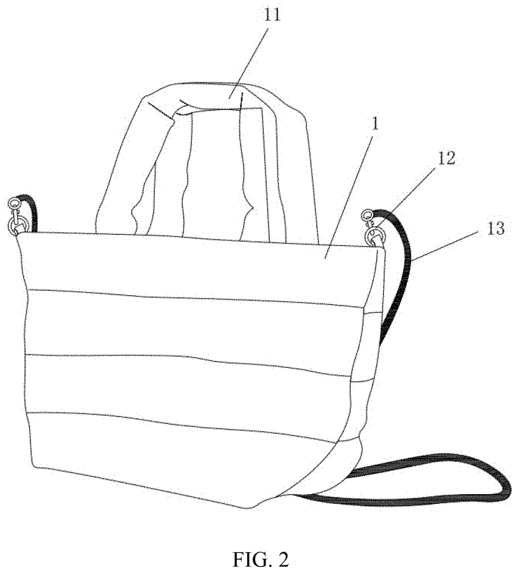

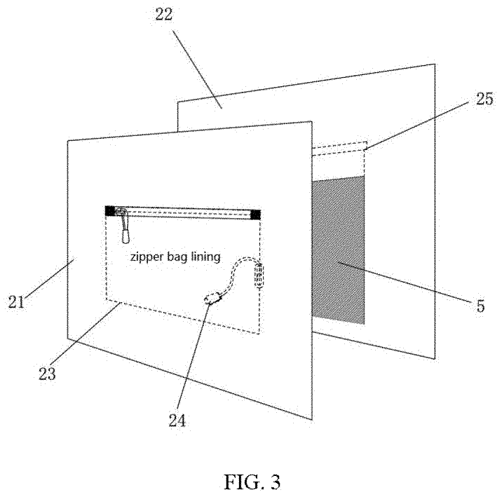

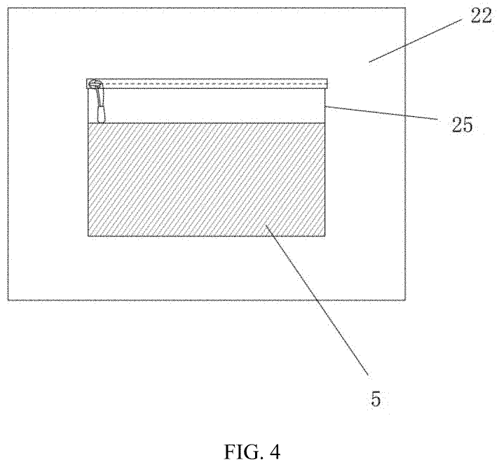

As shown in FIGS. 1 to 4, according to Embodiment 1 of the present disclosure, a bag with a hand warming function is provided. The bag may have a bag body 1, and the bag body 1 can maintain the original storage function of the bag and can store items with a large volume. The bag body 1 can be a shoulder bag, a handbag or a backpack. The bag body 1 shown in the figures is a dual-purpose bag for carrying and cross-body. A hand strap 11 is provided in the middle of the upper of the bag body 1, and lugs 12 are provided on both sides of the upper, and the lugs 12 may be detachably mounted with the braces 13.

A side bag 2 may be provided on one side of the bag body 1, and may be fixed on the bag body 1 in a detachable manner. A hand-in pace with a hand-in opening 3 may be formed between the side bag 2 and the bag body 1. As shown in the figures, the upper side and the lower side of the side bag 2 may be fixed on the bag body 1 in a detachable manner, such that the left and right sides of the side bag 2 and the bag body 1 form a hand-in opening 3, which is convenient for hand insertion from left and right. Further as shown in the figures, the upper and the lower sides of the side bag 2 can be respectively fixed on the bag body 1 by the a zipper 4. Alternatively, the upper and the lower sides of the side bag 2 can also be fixed on the bag body 1 by a stud respectively (not shown herein). Alternatively, the left and right sides of the side bag 2 may be detachably fixed on the bag body 1 to facilitate hand insertion from above, or be fixed in other ways, which will not be described in detail herein.

The side bag 2 may have a double-layer structure formed by stitching a shell fabric 21 and a lining 22. The shell fabric 21 may be provided with an outer pocket 23, and the outer pocket 23 may be used to hold power banks and small items, such that the side bag 2 further expands the storage capacity of the product. The outer pocket 23 on the shell fabric 21 may be preferably designed as a structure with three sides stitched and a zipper mounted on one side, so as to facilitate the placement of power bank and small items, and to prevent the power bank and small items from falling out. An outlet 24 may be mounted in the outer pocket 23, and the outlet 24 is used for connecting the power bank. An electric heating material 5 may be mounted on the lining 22, and the electric heating material 5 is connected with the outlet 24 by a wire (not shown in the figures), and the electric heating material 5 is powered by the power bank. Specifically, as shown in the figures, an inner pocket 25 is provided on the lining 22, and the inner pocket 25 is used for holding the electric heating material 5, and an inlet for connecting the electric heating material 5 may be mounted in the inner pocket 25 (not shown in the figures). The inlet is connected to the outlet 24 through a wire, so as to realize power supply to the electric heating material 5 by the power bank. Such a structure is convenient for the electric heating material 5 to be taken and placed flexibly, especially when the side bag 2 needs to be cleaned, the electric heating material 5 can be easily taken out. An interlayer can also be provided on the lining 22, and the electric heating material 5 may be fixed in the interlayer, but it is slightly inconvenient to clean. The inner pocket 25 on the lining 22 may be preferably designed as a structure with three sides stitched and a zipper mounted on one side, so as to facilitate the placement of the electric heating material 5 and prevent the electric heating material 5 from falling out.

The electric heating material 5 of the present disclosure may be preferably a graphene heating layer, and may also be other materials such as electric heating fibers, electric heating films, carbon fibers, lithium batteries or accumulators.

When in use, according to the present disclosure, after inserting hands between the bag body 1 and the side bag 2 through the hand-in opening 3, the hand warming function may be realized by heating with the electric heating material 5, the hand warming effect is good, and long-lasting hand warming can be realized. Moreover, relying on the electric heating material 5 to heat and warm the hands, the electric heating material 5 is light in weight and easy to carry, and is especially suitable for outdoor use, especially in cold places.

The present disclosure has excellent warming effect, does not need to select thick materials for production. The characteristics of the original bag, can be maintained, it is made of conventional materials, and is convenient for cleaning. If the side bag 2 is disassembled, the bag body 1 still maintains the original storage function of the bag, which is highly practical.

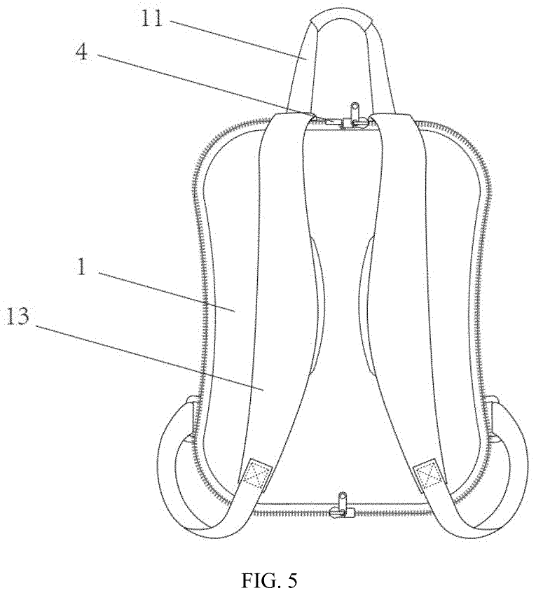

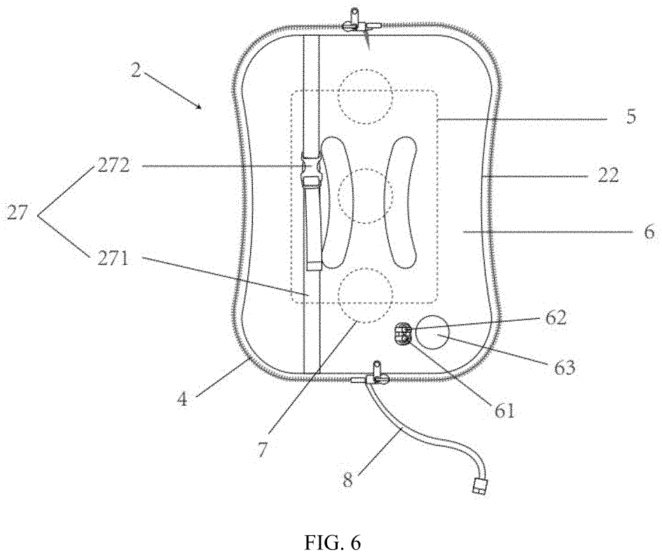

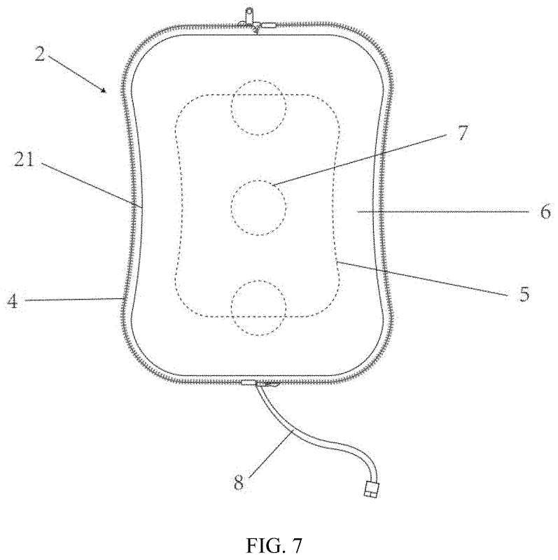

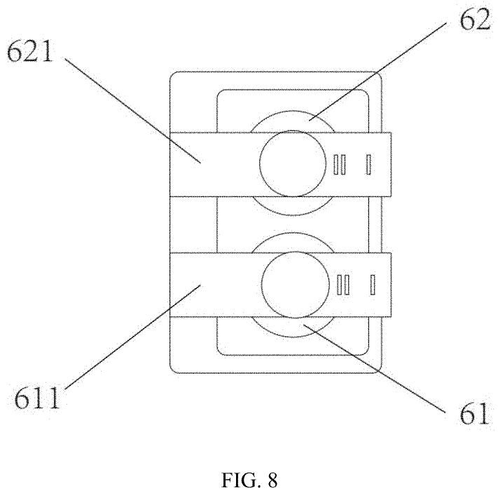

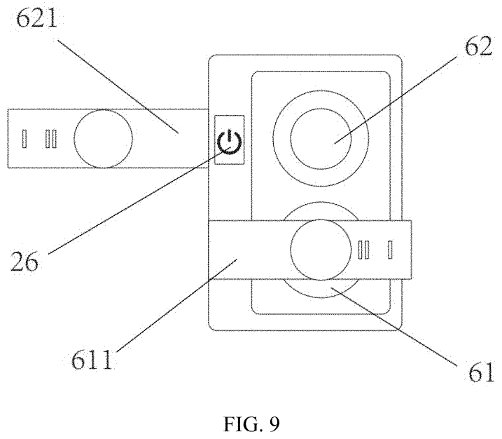

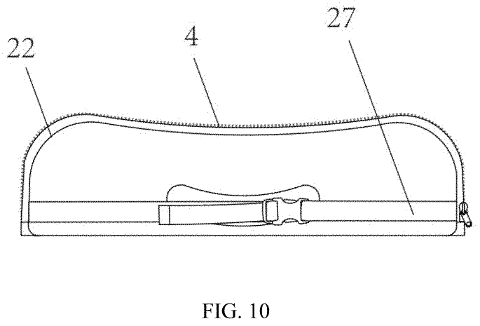

As shown in FIGS. 5 to 10, according to Embodiment 2 of the present disclosure, a multifunctional bag is provided. The multifunctional bag has a bag body 1. The bag body 1 maintains the original storage function of the bag, and can store items with a large volume. The bag body 1 can be a shoulder bag, a handbag or a backpack. The bag body 1 shown in the figures is a backpack with a hand strap 11 in the upper middle position of the bag body 1 and braces 13 on the back of the bag body 1.

The side bag 2 may be provided on the whole back of the bag body 1, and the side bag 2 may be fixed on the bag body 1 in a detachable manner. Specifically, the periphery of the side bag 2 is fixed on the bag body 1 through the zipper 4, such that an inner layer may be also formed between the side bag 2 and the bag body 1, and some small items can be temporarily stored. The side bag 2 can also be fixed on the bag body 1 by a stud (not shown herein), or be fixed by other methods, which will not be described in detail herein.

The side bag 2 may have a double-layer structure formed by stitching a shell fabric 21 and a lining 22.

The side bag 2 may be provided with an inflatable airbag 6 and a massager. The massager can be adopted in prior art, is mainly made up of a massage head 7 and a drive motor (not shown in the figures). The massager can adopt the existing product of suitable size to assemble directly. The massage head 7 and the electric heating material 5 may be mounted on the shell fabric 21 of side bag 2. The electric heating material 5 of the present disclosure may be preferably a graphene heating layer, and may also be other materials such as electric heating fibers, electric heating films, carbon fibers, lithium batteries or accumulators. The wires 8 of the electric heating material 5 and the driving motor pass out from the side bag 2 and are used to connect to a power bank, and the power bank (which can be placed in the bag body 1) supplies power to the driving motor of the electric heating material 5 and the massage head 7. An electric switch 26 may be mounted on the wire 8, and the electric switch 26 may be mounted on the lining 22 of side bag 2. When removing or partially removing the side bag 2, the electric switch 26 will be exposed, and then the electric switch 26 can be operated. The electric switch 26 is used to control the electric heating material 5 to be powered on or off (heating or stop heating), and the electric switch 26 can also be used for controlling the driving motor to be powered on or off (the massage head 7 works or stops working).

An inflation port 61 and a deflation port 62 may be also mounted on the lining 22 of side bag 2. The inflatable port 61 is used to inflate the airbag 6, and the deflation port 62 is used to deflate the airbag 6. The deflation port 62 may be provided side by side with the electric switch 26. A switch element may be provided between the deflation port 62 and the electric switch 26, and the switch element is used to switch and control the deflation port 62 and the electric switch 26. When the deflation port 62 is closed, the electric switch 26 is unable to be opened, and when the deflation port 62 is opened, the electric switch 26 is only able to be opened.

In the present disclosure, the inflation port 61 and the deflation port 62 may be respectively equipped with an inflation switch piece 611 and a deflation switch piece 621, wherein the deflation switch piece 621 can be used as the switch element for switching the inflation port 62 and the electric switch 26 to be powered on or off. As shown in the figures, when the deflation switch piece 621 is covered on the deflation port 62, the deflation port 62 is closed, and the electric switch 26 is blocked under the deflation switch plate 621, and is unable to be operated, so it cannot be opened; at this time, both the device and the electric heating material 5 do not work, and no thermal expansion will occur to cause the explosion of the inflatable airbag 6. When the deflation switch piece 621 is turned up and deviates from the deflation port 62, the deflation port 62 is opened, at this time, the inflatable airbag 6 automatically deflates, and the electric switch 26 is in an exposed state and can be opened by operation. After the electric switch 26 is turned on, the massager and the electric heating material 5 work to realize massage and heating effects. Meanwhile, the heat generated by the work of the massager and the electric heating material 5 will be taken out with the automatic deflation of the inflatable airbag 6. On the one hand, it plays the role of heat dissipation, on the other hand, the heat will not accumulate, avoiding the thermal expansion of the gas in the inflatable airbag 6, and ensuring the safety of use.

In order to facilitate the inflation operation and deflation operation, a press-type inflation valve 63 may be also mounted on the lining 22 of the side bag 2, and the press-type inflation valve 63 may be connected with the inflation airbag 6. The user can choose the press-type inflation valve 63 or the inflation port 61 to inflate the inflatable airbag 6. The deflation port 62 is closed when inflated, at this time, the massager and the electric heating material 5 also stop working. The deflation port 62 is opened when deflated, such that the inflatable airbag 6 can be deflated quickly. At this time, the electric switch 26 can be also opened as required, to select whether to use massage and heating function.

For the convenience of use, in the present disclosure, a tie 27 can be further mounted on the lining 22 of the side bag 2. When the side bag 2 is assembled on the bag body 1 through the zipper 4. The tie 27 can be hidden and not exposed. When the lining 22 is folded in half towards the shell fabric 21, it may be fixed by the zipper 4, such that the side bag 2 can form a pillow bag, and the tie 27 may be positioned at two ends of the pillow bag. The pillow bag can be easily fixed on the seat back through the tie 27. Alternatively, the pillow bag can be bent into a C shape and fixed on the user's neck. Specifically, the tie 27 may be composed of two straps 271 and a pair of adjusting buckles 272. ends of the two straps 271 may be respectively fixed on the lining 22 of the side bag 2 by corresponding to the two ends of the pillow bag. The pair of adjusting buckles 272 may be mounted at the other ends, through which two straps 271 can be buckled together in an adjustable manner, and the length of the tie 27 may be adjusted to facilitate fixing.

When in use, according to the present disclosure, the bag body 1 can be used as an ordinary backpack for storing items. After the side bag 2 is assembled on the bag body 1, the space between the side bag 2 and the bag body 1 can also be used as a temporary folding space.

The present disclosure can also inflate the inflatable airbag 6 of the side bag 2. The inflatable airbag 6 can be then assembled on the bag body 1 through the zipper 4 after inflating, such that the back of the bag is expanded as a whole. On the one hand, the expanded back can support the entire bag body 1 to make it more tangible, such that the bag body 1 with a soft fabric can achieve the effect similar to a hard backpack without collapsing, which is convenient for storing items, and the backpack can be placed upright. On the other hand, when carrying, the items in the bag can be prevented from squeezing human's body, and the comfort can be increased during carrying.

In the present disclosure, the side bag 2 can be also disassembled from the bag body 1, the inflatable airbag 6 can be inflated, and used as a back cushion. The back cushion can be fixed on the seat back by a tie 27 to pillow the user's head, neck or waist. Alternatively, the side bag 2 may be further inflated after being folded, bent into a C-shaped neck pillow, and used as a neck pillow. The neck pillow can be fixed on the user's neck by the tie 27, to provide comfortable support for the user's neck and head.

In the present disclosure, the massager can be also utilized to work with electricity, the massage function can be realized by the massage head 7. The electric heating material 7 can be also utilized to energize and generate heat to realize functions such as hand warming. Further, it can also be fixed on the seat back with the help of the tie 27, and the user's head, neck or waist can be hot compressed and massaged. Alternatively, the side bag 2 can be folded and bent into a C-shaped neck pillow as a neck pillow. It may be fixed on the user's neck by the tie 27 to provide hot compress and massage for the user's neck and head.

It should be noted that the bag body 1 of the present disclosure is not limited to the shape shown in the figures, and can be changed into various shapes according to design requirements, such as backpacks, handbags and the like in other shapes.

The above descriptions are only implementation examples of the present disclosure, and do not limit the protection scope of the present disclosure. It should be pointed out that equivalent changes made by those skilled in the art according to the design ideas of the present disclosure after reading the specification all fall within the scope of protection of the present disclosure.

What is claimed is:

1. A multifunctional bag, comprising a bag body provided with a side bag at one side of the bag body; wherein the side bag is detachably fixed on the bag body, the side bag has a double-layer structure formed by stitching a shell fabric and a lining; the side bag is mounted with an electric heating material, and the electric heating material is connected to an external power bank through a wire.

2. The multifunctional bag as claimed in claim 1, wherein a hand-in space with a hand-in opening is formed between the side bag and the bag body, the shell fabric of the side bag is provided with an outer pocket for storing the power bank and small items, the outer pocket is mounted with an outlet for connecting the power bank; and the electric heating material is mounted on the lining, and is connected with the outlet through the wire.

3. The multifunctional bag as claimed in claim 2, wherein an upper side and a lower side of the side bag are detachably fixed on the bag body, respectively, such that the hand-in opening is formed among a left side and a right side of the side bag and the bag body.

4. The multifunctional bag as claimed in claim 2, wherein an upper side and a lower side of the side bag are respectively fixed on the bag body through zippers.

5. The multifunctional bag as claimed in claim 2, wherein an upper side and a lower side of the side bag are respectively fixed on the bag body through studs.

6. The multifunctional bag as claimed in claim 2, wherein the outer pocket on the shell fabric has a structure in which three sides are stitched and one side is mounted with a zipper.

7. The multifunctional bag as claimed in claim 2, wherein the lining is provided with an interlayer, and the electric heating material is fixed in the interlayer.

8. The multifunctional bag as claimed in claim 2, wherein the lining is provided with an inner pocket for storing the electric heating material, and the electric heating material is placed in the inner pocket in a flexible manner; the inner pocket is mounted with an inlet for connecting the electric heating material, and the inlet is connected with the outlet through the wire.

9. The multifunctional bag as claimed in claim 8, wherein the inner pocket on the lining has a structure in which three sides are stitched and one side is mounted with a zipper.

10. The multifunctional bag as claimed in claim 1, wherein the side bag is provided on an entire back of the bag body, the side bag is provided with an inflatable airbag and a massager composed of a massage head and a driving motor; the massage head and the electric heating material are mounted on the shell fabric of the side bag, wires of the electric heating material and the driving motor pass out from the side bag for connecting to the power bank, and the wires are mounted with an electric switch configured for controlling a power on-off for the electric heating material and the driving motor, the electric switch is mounted on the lining of the side bag; the lining of the side bag is further mounted with an inflation port for inflating the inflatable airbag, and a deflation port for deflating the inflatable airbag; the deflation port and the electric switch are arranged side by side; a switch element is provided between the deflation port and the electric switch, and the switch element is configured for switching and controlling that the electric switch is unable to be turned on when the deflation port is closed, and the electric switch is able to be turned on only after the deflation port is opened.

11. The multifunctional bag as claimed in claim 10, wherein the inflation port and the deflation port are respectively equipped with an inflation switch piece and a deflation switch piece, and the deflation switch piece is the switch element;
when the deflation switch piece is covered on the deflation port, the deflation port is closed, and the electric switch is blocked under the deflation switch piece and unable to be opened; and
when the deflation switch piece deviates from the deflation port, the deflation port is opened, and the electric switch is exposed and able to be opened.

12. The multifunctional bag as claimed in claim 10, wherein the lining of the side bag is further mounted with a press-type inflation valve, and the press-type inflation valve is connected with the inflatable airbag.

13. The multifunctional bag as claimed in claim 10, wherein a periphery of the side bag is fixed on the bag body through a zipper.

14. The multifunctional bag as claimed in claim 13, wherein the lining of the side bag is further mounted with a tie; when the lining is folded to the shell fabric, the lining is fixed by a zipper, such that the side bag forms a pillow bag with the tie positioned at two ends of the pillow bag.

15. The multifunctional bag as claimed in claim 14, wherein the tie is composed of two straps and a pair of adjusting buckles; ends of the two straps are respectively fixed to the lining of the side bag by corresponding to two ends of the pillow bag, another ends of the two straps are mounted with the pair of adjusting buckles, and the two straps are capable to be buckled together through the pair of adjusting buckles.

16. The multifunctional bag as claimed in claim 1, wherein the bag body is a shoulder bag, a handbag or a knapsack.

17. The multifunctional bag as claimed in claim 1, wherein the bag body is provided with a hand strap in a middle of an upper of the bag body, and lugs at both sides of the upper of the bag body, and the lugs are detachably mounted with braces.
